(19) United States
(12) Patent Application Publication
(10) Pub. No.: US 2010/0253484 A1
(43) Pub. Date: Oct. 7, 2010

(54) PHARMACEUTICAL SUPPLY PACKAGE

(75) Inventors: Tom Aelbrecht, Beerse (BE); Roger Gustaaf J. Lauwers, Beerse (BE)

Correspondence Address: WOODCOCK WASHBURN LLP, CIRA CENTRE, 12TH FLOOR, 2929 ARCH STREET, PHILADELPHIA, PA, 19104-2891, US

(73) Assignee: JANSSEN PHARMACEUTICA N.V., Beerse (BE)

(21) Appl. No.: 12/740,254

(22) PCT Filed: Oct. 29, 2008
(86) PCT No.: PCT/IB2008/002882

§ 371 Date: Apr. 28, 2010

(30) Foreign Application Priority Data
Nov. 1, 2007 (EP) 07254340.8

(51) Int. Cl. H04Q 5/22

(52) U.S. Cl. 340/10.42

(57) ABSTRACT

A pharmaceutical supply package comprising: a memory storing an identifier specific to the pharmaceutical supply package; a transmitter operable to transmit the identifier for reception by a reception device external to the pharmaceutical supply package; and a receiver operable to receive data and to store the received data in the memory.

### FIELD OF THE INVENTION

The present invention relates to pharmaceutical supply packages, and systems and methods for using pharmaceutical supply packages.

### BACKGROUND OF THE INVENTION

FIG. 1 of the accompanying drawings schematically illustrates a known pharmaceutical supply package 100 (also known as a patient kit or clinical supply package). The package 100 comprises a box 102 into which a pharmaceutical wallet 104 (or tray or sheet) may be inserted and stored. The wallet 104 comprises one or more blisters 106, which are discrete sealed storage chambers for storing a quantity (e.g. a tablet or a pill) of a pharmaceutical product or composition (e.g. an active drug or a placebo). A blister 106 may be sealed in many ways, for example by a metal foil, such as an aluminium foil, (not shown) covering the storage chamber. A patient may open the box 102 using a flap 108 and remove the wallet 104 from the box 102. Having done so, the patient may break the seal of a blister 106 to access the pharmaceutical product stored therein. It will be appreciated that other pharmaceutical supply packages for providing pharmaceutical products to a patient may be used and they may have a different structure from that shown in FIG. 1.

Clinical trials are conducted when developing a new pharmaceutical product. The developers of the pharmaceutical product supply investigators (such as pharmacists, chemists, doctors, hospitals, etc.) with packages 100 for use in the clinical trial. The developers may, first, provide the packages 100 to distributors, who then deliver and provide the investigators with the packages 100 on behalf of the developers. The investigators then provide their patients (test subjects or users) with one or more of the packages 100 over the period of the clinical trial. The patients then use the pharmaceutical product provided in their packages 100 in accordance with the clinical trial being conducted. The investigators obtain trial results from the patients and report back to the product developers accordingly.

Naturally, each package 100 is labelled so that it can be identified and its contents determined.

The packages 100 used during the clinical trial may contain the active pharmaceutical product that has been developed or may contain a placebo. The distribution of active and placebo packages 100 is driven by randomisation tables, as is known in this field of technology. The dose or concentration of the active pharmaceutical product may vary between the packages 100 according to the tests required for the clinical trial. Additionally, the dose or concentration of the active pharmaceutical product supplied to a patient during the clinical trial may vary from package 100 to package 100. For example, the dose or concentration may be determined according to the age, sex, weight, geographical location, or some other property of the patient. Information regarding the nature and dosage of the pharmaceutical product may be reflected on the labelling applied to the package 100.

Additionally, different countries often have different regulations governing the conduct of clinical trials. The countries involved in a clinical trial may also have different climates and this can affect the clinical trials. For example, the tropical climate of an equatorial country may cause the expiry date of a drug being trialled in that country to be earlier than the expiry date for the same drug being trialled in a European country having an extra-tropical climate.

Consequently, some clinical trials involve generating and providing packages 100 on a country-specific basis, with each package 100 being tailored according the country to which it will be sent. To this end, the packages 100 may be provided with country-specific labels that use the language of that country and that indicate country-specific data (such as an expiry date relevant to that country) and product-related data (such as the dosage or concentration of the pharmaceutical product and a suitable regime for the patient to use the pharmaceutical product being trialled). This country-specific approach increases the time and cost of running the clinical trial.

It is common to over-supply a country with packages 100 that are specific to that country. For example, patients may drop out of a clinical trial or fewer than expected patients may enroll into the clinical trial. The unused packages 100 cannot then be re-used in another country without undergoing a re-labelling procedure for the new country. Hence, there is either waste incurred (when unused packages 100 are disposed of) or there is additional time and cost incurred by undergoing a re-labelling procedure. The additional time is incurred not only due to the generation and application of new labels, but also the cross-checks that need to be performed to ensure that correct new labels are put on the correct packages—it could be hazardous to the patient's health and could affect the clinical trial results if, for example, a label relating to a placebo is placed on a package 100 containing an active drug, or an incorrect regime for taking the pharmaceutical product is indicated on the package 100 by applying an incorrect label.

An alternative approach to supplying packages 100 to multiple countries has been to use a multi-lingual booklet that is attached (e.g. adhered by glue) to the package 100. An example of such a multi-lingual booklet is illustrated in FIGS. 2a and 2b of the accompanying drawings.

On the front of the booklet is an English-language label 200 having various information in English. For example, the information may include:
the compound number 202 of the pharmaceutical product being provided in the package 100, which in this case is “R076477SCH3018”;
a trial authorisation number 204 provided by the regulatory authority that has authorised the clinical trial, which in this case is “2006-006642-34”;
data 206 relating to the nature and quantity of the pharmaceutical product being supplied, but note that even if the package 100 contains a placebo, the data 206 indicates data relating to the active drug of the clinical trial so that the patient is not made aware that a placebo is being provided;
a package ordering number 208, which in this case is “353284”;
a medication number 210, (or box number or package number), which in this case is “300000”;
data 212 relating to the patient, investigator and stage of the trial—this information can only be entered onto the label 200 when the investigator provides the patient with the package 100;
a batch number 214, or lot number, that provides manufacturing information relating to the preparation of the bulk compound used, which in this case is “7AG1026-X”; and
data 216 relating to storage and use of the pharmaceutical product being supplied (such as expiry date and appropriate temperature ranges and humidity conditions).

The medication number 210 is a trial randomization number. Some packages 100 will have an active drug, whilst others will have a placebo. The medication number 210 provides the key to determining whether or not a particular package 100 contains an active drug or a placebo. The combination of the medication number 210 and the package order number 208 uniquely identifies the package 100. There is only one medication number 210 for one package order number 208.

Inside the multi-lingual booklet are a number of pages, in various languages. Each page refers to some or all of the information provided on the English-language label 200. FIG. 2b illustrates a French-language page 220 of the multi-lingual booklet. For example, the French-language page 220 has text 222 indicating, in French, how to determine the expiry date for the package 100, by referring to the relevant data 216 on the English-language label 200.

The number of different pages included in the multi-lingual booklet is determined according to the number of different languages used in the various countries across which the clinical trial is being conducted. For each possible language used during the clinical trial, a corresponding page in the multi-lingual booklet is provided.

However, it is common to extend a clinical trial, during the course of the clinical trial, to other countries. These new additional countries may have one or more languages that are not catered for by the multi-lingual booklets that have been used so far during the clinical trial. If this happens, then the existing multi-lingual booklets have to be replaced by new, updated multi-lingual booklets with corresponding additional language pages so that future packages 100 for the clinical trial can be labelled and distributed. This naturally involves waste of existing labels as well as increased costs and time.

Furthermore, as the clinical trial is conducted, new information about the drug being tested is often discovered or determined. This can have an effect on the data provided by the English-language label 200, such as the expiry date or storage temperature information. For example, it is common, at the beginning of a clinical trial, to use an expiry date representing a short shelf-life of, say, a couple of months. However, as the trial progresses, this shelf-life may be extended to, say, a year. If this happens, then (i) new multi-lingual booklets (or at least new English-language labels 200) have to be prepared for new packages 100; or (ii) new multi-lingual booklets have to be distributed to investigators so that the investigators can put them on the packages 100 that they have been given and are now storing themselves; or (iii) new multi-lingual booklets have to be provided to the package 100 distributors, so that the distributors can put them on their packages 100 before distributing the packages 100 to the investigators. Alternatively, the investigators could be instructed to manually correct their existing multi-lingual booklets. These approaches incur additional costs for the clinical trial (both in terms of time and labour). Additionally, errors can be introduced as some of the packages 100 may not be updated, or may be updated incorrectly, which potentially poses risks to the patients and may also adversely affect the results of the clinical trial.

Additionally, when a patient re-visits an investigator during the clinical trial to obtain a second (or subsequent) package 100, it is important that a correct appropriate subsequent package 100 is supplied to that patient. For example, if the patient is being provided with a placebo, then it is important that all packages 100 given to that patient contain a placebo. Alternatively, if the patient is being provided with a specific dosage of an active drug, then this specific dosage needs to be maintained throughout the lifetime of the clinical trial. If an inappropriate package 100 is provided to a patient, then risks may be posed to the patient (e.g. if the dosage of the drug is inappropriate for that patient, due to age, sex, etc.) and the results of the clinical trial may be adversely affected. However, current methods of distribution of packages 100 by investigators to patients do not provide adequate measures and do not have fully proved features to ensure that an appropriate package 100 is always provided to each patient.

It is therefore clear that there are numerous problems associated with current package labelling, distribution and supply methods during clinical trials, which can result in the waste of pharmaceutical products and packages 100 and additional cost, time and labour. It would therefore be desirable to address these, and other, problems.

### SUMMARY OF THE INVENTION

According to an aspect of the invention, there is provided a pharmaceutical supply package comprising: a memory storing an identifier specific to the pharmaceutical supply package; a transmitter operable to transmit the identifier for reception by a reception device external to the pharmaceutical supply package; and a receiver operable to receive data and to store the received data in the memory. By storing a unique identifier that can be output by the output device (or channel or port) of the package, the identity of the package can be determined. This can then be used to determine data specific to that package. It can also be used to verify that a package that an investigator is about to given a patient is indeed the correct package to give to that patient. Additionally, using the receiver (which may be an input device or channel or port), the package can be configured to store data specific to the package.

For example, the package may comprise an electronic-label, or display, for providing a visual display of at least some of the data received and stored in the memory. This means that multi-lingual booklets would no longer be necessary.

The display may be any kind of display suitable for displaying data stored in the memory. The display may require electrical power to provide the visual display of the at least some of the data stored in the memory (e.g. an LCD or LED display), in which case there may be a switch for causing the display to provide or to stop providing the visual display. This helps conserve energy, which is particularly useful when the package makes use of a battery. Alternatively, the electronic-label, or display, may comprise: a heat-sensitive component, wherein the visual appearance of the heat-sensitive component changes in response to application of heat to the heat-sensitive component; and a heat-applicator arranged to apply heat to the heat-sensitive component to change the visual appearance of the heat-sensitive component to display the at least some of the data stored in the memory.

The transmitter may be operable to transmit at least some of the data received by the receiver and stored in the memory. The data output by the transmitter may include the identifier in addition to some of the other data stored in the memory. The data transmitted by the transmitter may be received by, and displayed at, a device external to the pharmaceutical supply package. This means that the package need not have its own display. The use of the external device to display the data means that the package need not use a multi-lingual booklet.

A system according to an embodiment of the invention comprises: a pharmaceutical supply package, the pharmaceutical supply package comprising: a memory storing an identifier specific to the pharmaceutical supply package; and a transmitter operable to transmit the identifier for reception by a reception device external to the pharmaceutical supply package; a reception device operable to receive, from the pharmaceutical supply package, the identifier specific to the pharmaceutical supply package; and a control system operable to communicate with the reception device and comprising a database storing data associated with a plurality of pharmaceutical supply packages, wherein the control system can retrieve the data associated with a pharmaceutical supply package using the identifier specific to that pharmaceutical supply package; wherein the control system is arranged to assign a pharmaceutical supply package to a user; and wherein the control system, on receipt from the reception device of an identifier received by the reception device from a particular pharmaceutical supply package, is arranged to check that the particular pharmaceutical supply is the pharmaceutical supply package assigned to the user. Such a system makes use of the identifier stored by the package to ensure that the correct, and only the correct, package is given to a patient. This helps prevent health risks that may otherwise be posed to the patient and helps ensure that the results of a clinical trial are accurate. The pharmaceutical supply package may be any one of the above-mentioned pharmaceutical supply packages.

Another system according to an embodiment of the invention comprises: at least one of the above-mentioned pharmaceutical supply packages; a reception device operable to receive, from the pharmaceutical supply package, the identifier specific to the pharmaceutical supply package; and a control system operable to communicate with the reception device and comprising a database storing data associated with a plurality of pharmaceutical supply packages, wherein the control system can retrieve the data associated with a pharmaceutical supply package using the identifier specific to that pharmaceutical supply package; wherein the reception device is operable, upon receipt of the identifier specific to the pharmaceutical supply package, to communicate the identifier to the control system to obtain, from the database, some or all of the data associated with the pharmaceutical supply package, the control system being operable to communicate the some or all of the data associated with the pharmaceutical supply package to the reception device; and wherein the reception device is operable to supply the obtained data to the pharmaceutical supply package via the receiver of the pharmaceutical supply package.

This system may comprise a terminal operable to receive, from the pharmaceutical supply package, data stored in the memory of the pharmaceutical supply package and transmitted by the pharmaceutical supply package; wherein the terminal comprises a display for providing a visual display of at least some of the data received by the terminal from the pharmaceutical supply package. Such a terminal may be a personal mobile device, such as a mobile telephone, PDA, laptop, etc.

Another system according to an embodiment of the invention comprises: at least one of the above-mentioned pharmaceutical supply packages; a device operable to receive, from the pharmaceutical supply package, the identifier specific to the pharmaceutical supply package; and a control system operable to communicate with the device and comprising a database storing data associated with a plurality of pharmaceutical supply packages, wherein the control system can retrieve the data associated with a pharmaceutical supply package using the identifier specific to that pharmaceutical supply package; wherein the device is operable, upon receipt of the identifier specific to the pharmaceutical supply package, to communicate the identifier to the control system to obtain, from the database, some or all of the data associated with the pharmaceutical supply package, the control system being operable to communicate the some or all of the data associated with the pharmaceutical supply package to the device; and wherein the device comprises a display for providing a visual display of at least some of the received data to a user of the device. Such a device may be a personal mobile device, such as a mobile telephone, PDA, laptop, etc.

The above-mentioned systems are particularly useful for conducting clinical trials.

According to an aspect of the invention, there is provided a method of using a pharmaceutical supply package, the pharmaceutical supply package comprising: a memory storing an identifier specific to the pharmaceutical supply package; and a transmitter operable to transmit the identifier for reception by a reception device external to the pharmaceutical supply package; wherein the method comprises: assigning, to a user, a particular pharmaceutical supply package intended for use by the user; identifying a pharmaceutical supply package; determining whether the identifier specific to the identified pharmaceutical supply package corresponds to the identifier specific to the pharmaceutical supply package assigned to the user; and if the identifier specific to the identified pharmaceutical supply package corresponds to the identifier specific to the pharmaceutical supply package assigned to the user, providing the identified pharmaceutical supply package to the user. The pharmaceutical supply package may be any one of the above-mentioned pharmaceutical supply packages.

According to an aspect of the invention, there is provided a method of using at least one of the above-mentioned pharmaceutical supply packages, wherein the method comprises: receiving the identifier specific to the pharmaceutical supply package; accessing a database that stores data associated with a plurality of pharmaceutical supply packages, by using the received identifier to retrieve some or all of the data associated with the pharmaceutical supply package; and storing the retrieved data in the memory of the pharmaceutical supply package.

If the pharmaceutical supply package has a display, then the method may comprise displaying, on the display of the pharmaceutical supply package, at least some of the data stored in the memory of the pharmaceutical supply package.

Furthermore, the method may comprise: transmitting at least some of the data stored in the memory of the pharmaceutical supply package to a device, the device having a display; and displaying, on the display of the device, at least some of the data transmitted to the device by the pharmaceutical supply package.

According to an aspect of the invention, there is provided a method of using at least one of the above-mentioned pharmaceutical supply packages, wherein the method comprises: transmitting the identifier specific to the pharmaceutical supply package from the pharmaceutical supply package to a device, the device having a display; using the received identifier to access a database that stores data associated with a plurality of pharmaceutical supply packages and retrieve some or all of the data associated with the pharmaceutical supply package; and displaying, on the display of the device, at least some of the data retrieved from the database.

The above-mentioned methods may comprise formatting the data retrieved from the database into a predetermined language.

The above-mentioned methods are particularly useful for conducting clinical trials that use one or more of the above-mentioned pharmaceutical supply packages.

According to another aspect of the invention, there is provided a computer program which, when executed by a computer, carries out at least one of the above-mentioned methods. This computer program may be carried on a data carrying medium such as a storage medium (such as a CD-ROM or a DVD) or a transmission medium (such as a network cable or broadcast transmission).

### BRIEF DESCRIPTION OF THE DRAWINGS

Embodiments of the invention will now be described, by way of example only, with reference to the accompanying drawings, in which:

FIG. 1 schematically illustrates a known pharmaceutical supply package;

FIG. 2a illustrates an English-language label of a known multi-lingual booklet;

FIG. 2b illustrates a French-language page of a known multi-lingual booklet;

FIGS. 3a-3c schematically illustrate pharmaceutical supply packages according to embodiments of the invention;

FIGS. 4a-4d schematically illustrate systems according to embodiments of the invention;

FIG. 5 is a flowchart schematically illustrating the operation of the system illustrated in FIG. 4a when a patient initially enrolls into a clinical trial;

FIG. 6 is a flowchart schematically illustrating the operation of the system illustrated in FIG. 4a when a patient who has already enrolled into a clinical trial and has already been provided with a pharmaceutical supply package returns to an investigator;

FIG. 7 is a flowchart schematically illustrating the operation of the system illustrated in FIG. 4b or FIG. 4c when a patient initially enrolls into a clinical trial; and

FIG. 8 is a flowchart schematically illustrating the operation of the system illustrated in FIG. 4d when a patient initially enrolls into a clinical trial.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader scope of the invention as set forth in the appended claims.

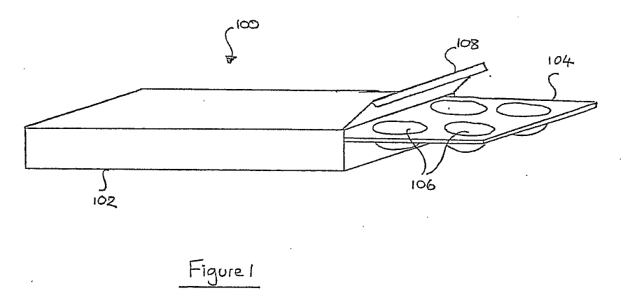

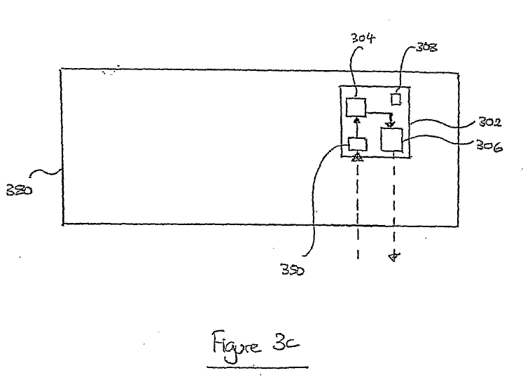

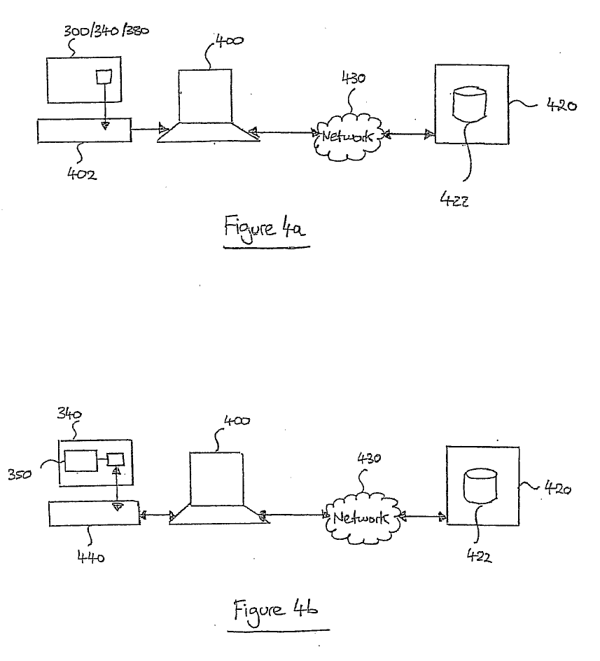

FIG. 3a schematically illustrates a pharmaceutical supply package 300 (also known as a patient kit or clinical supply package) according to an embodiment of the invention. The package 300 is of a similar physical form to the package 100 of FIG. 1.

The package 300 comprises an electronic device 302 that has a memory 304 and a transmitter 306 coupled to the memory 304. The electronic device 302 may be a microchip, an integrated circuit, a semiconductor device, or any other electronic device capable of providing the functionality that will be described below.

The memory 304 stores an identifier specific to the package 300, i.e. the identifier stored in the memory 304 of a package 300 uniquely identifies that package 300 or is at least specific to that package 300 within the clinical trial. The identifier may be a number, a text string, a combination of numbers, letters, or other characters, or any other form of data that can be stored in the memory 304 and used as a unique identifier specific to the package 300. This identifier may be composed of a single identifier, or may be made up of multiple identifiers (such as a combination of an identifier identifying the clinical trial and an identifier identifying a number for the package 300 being used within that particular clinical trial) that, together, uniquely identify the package 300.

The memory 304 may be a read-only-memory, for example if it is to be configured once with the unique identifier. Alternatively, the memory 304 may be a random-access-memory, for example if it is to be re-configurable, such as for re-use within the same, or a subsequent, clinical trial in which a different identifier is to be used for the package 300. Additionally, as will be described later, in some embodiments of the invention, the memory 304 is used to store data transmitted to, and received at, the pharmaceutical supply package, in which case the memory 304 is a random-access-memory. Any suitable memory means may be used for the memory 304, as is known in this field of technology.

The transmitter 306 may be any kind of device which, under the control of the electronic device 302, can read and transmit some or all of the data stored in the memory 304 (including the unique identifier of the package 304). For example, the transmitter 306 may transmit data via electromagnetic waves (such as by Bluetooth or by an infrared link). In this way, the package 300 may communicate data stored in the memory 304 via wireless communication. Alternatively, the transmitter 306 may be arranged to cooperate with a receiver (not shown in FIG. 3a) when it is brought into contact with the receiver. This may be achieved by any known contact (i.e. non-wireless) communication means. The transmitter 306 may simply be an interface between the memory 304 and the external receiver, allowing the external receiver to read data from the memory 304.

The electronic device 302 of FIG. 3a is powered by a battery 308. The battery 308 is capable of supplying a suitable level of electrical power to the electronic device 302 for a suitable period of time (such as sufficient power to operate the memory 304 and the transmitter 306 for the expected duration of the clinical trial). Alternatively, the electronic device 302 may be powered by other means, such as a solar-cell. This allows for a potentially unlimited period of power supply to the electronic device 302, which may be particularly suitable when the duration of the clinical trial is long, or is unknown. A combination of various powering means, such as a combination of both a solar-cell and a battery 308 to power the electronic device 302, may be also used. Furthermore, the electronic device 302 may not have its own electrical power supply but may, instead, be arranged to receive power from an external device. For example, if the transmitter 306 communicates via a physical connection with an external receiver, then this physical connection may be used to provide power to the electronic device 302. Alternatively, the electronic device 302 may be powered by induction, i.e. without actually requiring a physical connection between the package 300 and another device.

The transmitter 306 may be constantly transmitting data stored in the memory 304. Alternatively, the transmitter 306 may be arranged to cooperate with an external receiver (not shown in FIG. 3a) so the transmitter 306 only provides data to the external receiver when the external receiver is nearby or has requested that data be provided to it. Again, this may be achieved by any known technique in this field of technology. As an example, if the electronic device 302 is powered by inductively coupling it to an external device, then the transmitter 306 may be arranged to transmit the data stored in the memory 304 when a suitable level of electrical power is achieved.

FIG. 3b schematically illustrates a pharmaceutical supply package 340 (also known as a patient kit or clinical supply package) according to another embodiment of the invention. The package 340 of FIG. 3b is the same as the package 300 of FIG. 3a, but with additional features, as described below.

The electronic device 302 of the package 340 comprises a receiver 350 arranged to receive data from a transmitter external to the package 340 (not shown in FIG. 3b). The electronic device 302 of the package 340 is arranged so that it may store the data received by the receiver 350 in the memory 304.

The receiver 350 may be any kind of device for receiving data from an external transmitter. For example, the receiver 350 may receive data via electromagnetic waves (such as by Bluetooth or by an infrared link). In this way, the package 340 may receive and store data in the memory 304 via wireless communication. Alternatively, the receiver 340 may be arranged to cooperate with the external transmitter when it is brought into contact with the external transmitter. This may be achieved by any known contact (i.e. non-wireless) communication means. The receiver 340 may simply be an interface between the memory 304 and the external receiver, allowing the external receiver to write data to the memory 304.

It will be appreciated that the transmitter 306 and the receiver 350 may cooperate together. For example, the electronic device 302 may transmit data stored in the memory 304 only when it has received an instruction requesting the transmission of the data. This instruction may be received by the receiver 350, at which point the electronic device 302 causes the transmitter 306 to transmit the data. Any known communications methods and protocols may be used by the electronic device 302 and its transmitter 306 and receiver 350.

The transmitter 306 is arranged so that it can transmit some or all of the data that has been received and stored in the memory 304 by the receiver 350.

Thus, the transmitter 306 and the receiver 340 may be in the form of an input-output interface. This input-output interface may be active (in that it is powered by the package 300, and actively sends out data and actively requests and receives data). The input-output interface may be passive (in that it is unpowered and serves merely as an interface allowing an external device itself to directly write to the memory and read from the memory).

The package 340 has a display (or electronic label) 352 for providing a visual display of at least some of the data stored in the memory 304. The display 352 is coupled to the electronic device 302 so that the electronic device 302 can arrange for data stored in its memory 304 to be communicated to the display 352, with the display then being arranged to display the information that it has received in a human readable form. Techniques for causing the data stored in the memory 304 to be displayed by the display 352 are well-known and shall not be described in detail herein.

For example, the display 352 may be an electrically powered display (e.g. receiving electrical power from the battery 308), such as an LCD or LED display panel requiring electrical power in order to display (and maintain the display of) data stored in the memory 304. Preferably, the display is flexible, as this helps prevent the display 352 from being damaged if the package 340 is twisted, squashed, etc.

Alternatively, the display 352 may comprise a heat-sensitive component (such as heat-sensitive paper or fabric) that changes visual appearance (e.g. changing colour or shade, or swapping between black and white) upon the application of heat. In this case, the display 352 comprises a heater (or heat-applicator) that is arranged to apply heat to the heat-sensitive component in a controlled manner so as to change its visual appearance to display some or all of the data stored in the memory 304. Such a display 352 may be a one-time-only display—i.e. once the visual appearance of the heat-sensitive component has been changed, then it cannot be changed back so that the information displayed by the display 352 cannot then be updated. Alternatively, the heat-sensitive component may be such that its visual appearance can be modified repeatedly (as opposed to the above non-repeatable visual modification), so that the information displayed by the display 352 can be updated.

The package 340 may comprise a switch 354 (or button or activator) that is used to control power to the display 352. For example, the switch 354 may be used to toggle between (i) providing power to a display 352 so that the display 352 provides a visual display of data in the memory 304 and (ii) ceasing providing power to the display 352 so that the display 352 no longer provides a visual display of data in the memory 304. Alternatively, the switch 354 may activate a timer (not shown) so that the display 352 is activated (and provides the visual display) only for a predetermined period of time. The switch 354 is therefore useful for conserving the power of the battery 308 (or other power supply means), thereby lengthening the life-span of the electronic device 302.

FIG. 3c schematically illustrates a pharmaceutical supply package 380 (also known as a patient kit or clinical supply package) according to another embodiment of the invention. The package 380 of FIG. 3c is the same as the package 340 of FIG. 3b, but without the display 352 or the switch 354. Thus, the package of FIG. 3c is the same as the package 300 of FIG. 3a, but with the addition of the receiver 350.

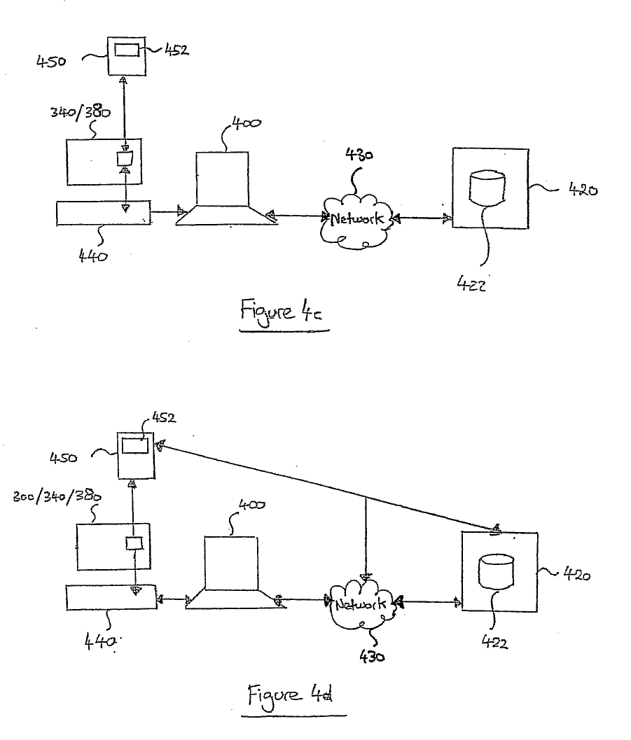

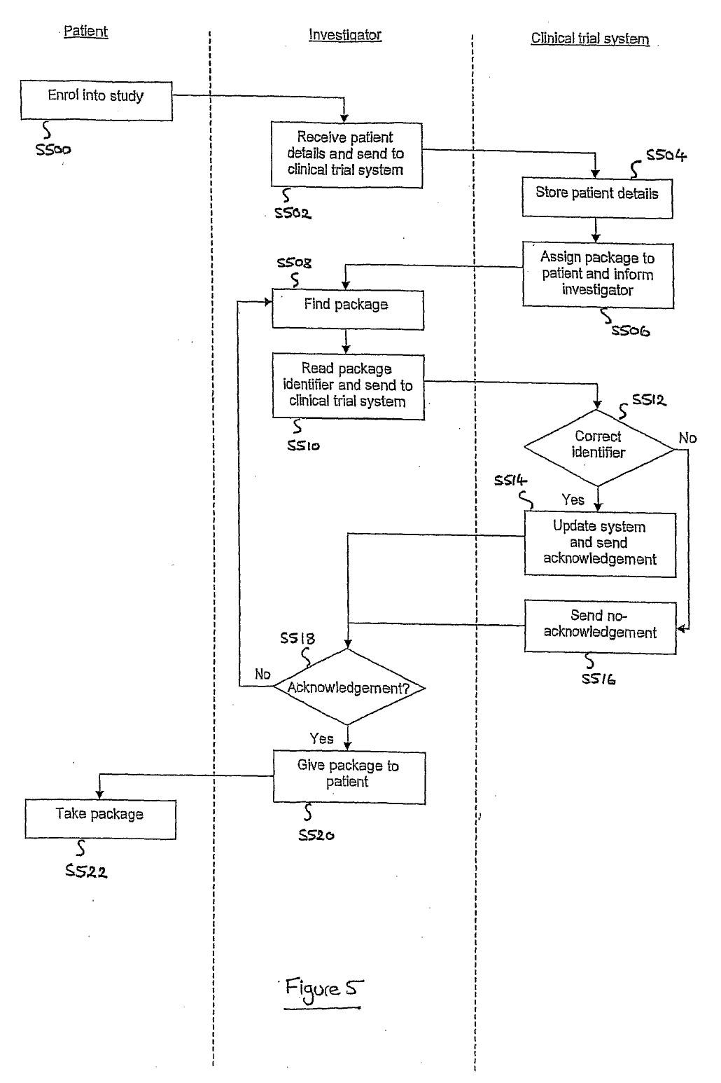

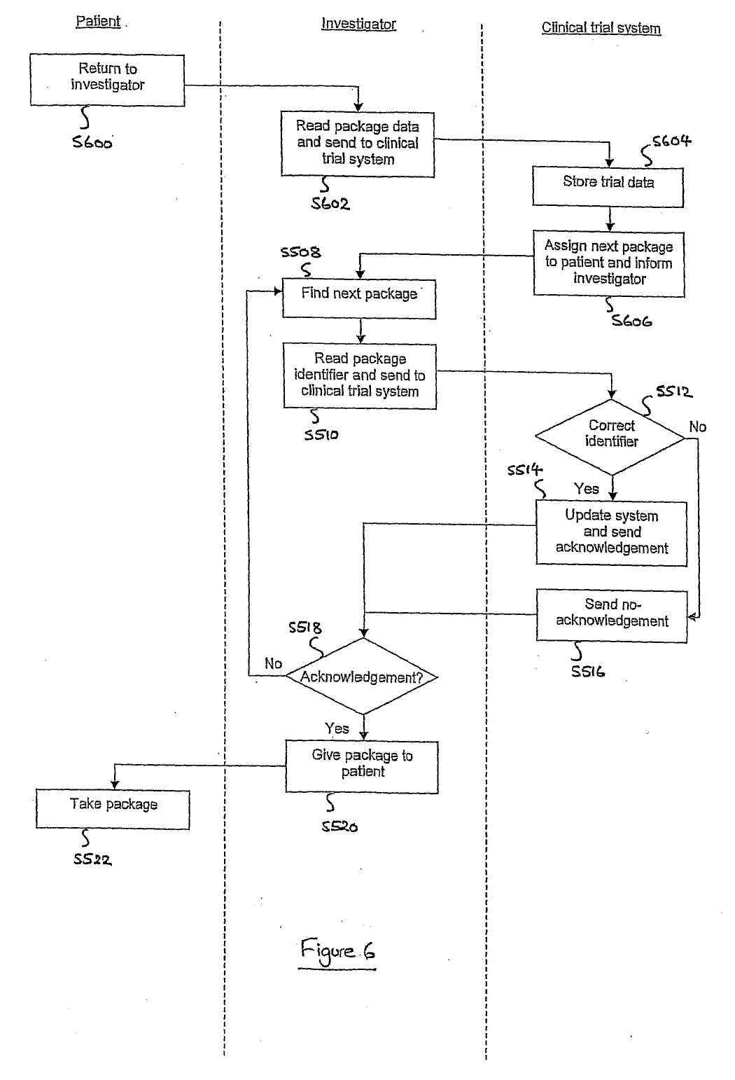

FIG. 4a schematically illustrates a system according to an embodiment of the invention.

An investigator-side arrangement consists of a computer 400 used by one of the investigators. The computer 400 executes one or more computer programs (software) for use in the clinical trial, as described in more detail below. It will be appreciated that multiple investigators (such as pharmacists, chemists, doctors, hospitals, etc.) may be used in the clinical trial, but that for simplicity, only one is shown in FIG. 4a. The computer 400 is connected to a data receiver 402 (or input device or reception device) that is able to receive data transmitted from a package 300 of FIG. 3a or from a package 340 of FIG. 3b or from a package 380 of FIG. 3c, via the transmitter 306 of the package 300/340/380. The receiver 402 may be any receiver suitable for cooperating with the transmitter 306 of the package 300/340/380. For example, if the transmitter 306 is a Bluetooth transmitter then the receiver 402 is a Bluetooth receiver, whereas if the transmitter 306 is an infrared beam transmitter then the receiver 402 is an infrared receiver, whereas if the transmitter 306 requires a physical connection to transmit data stored in the memory 304 of the package 300/340/380, then the receiver 402 comprises a suitable connection that cooperates with the transmitter 306 to form the required physical link.

The receiver 402 may be integral to the computer 400 or may be a separate device coupled to the computer 400 (for example, via a USB connection). Additionally, the computer 400 may be any general purpose computer or may be a computer specifically designed for implementing embodiments of the invention.

The system also comprises a clinical trial system 420 (or control system), which may take the form of one or more computers. The clinical trial system 420 executes one or more computer programs (software) for use in the clinical trial, as described in more detail below. The clinical trial system 420 and the investigator's computer 400 may communicate with each other, for example over the Internet or an intranet, or indeed any communications network 430 suitable sending data between the computer 400 and the clinical trial system 420.

The clinical trial system 420 comprises a database 422 that stores and provides information relevant to the clinical trial or, if more than one clinical trial is being conducted, the clinical trials. The data stored in the database 422 may be arranged, sorted, and ordered in any suitable manner as is well-known in the field of databases.

The database 422 stores patient details (such as name, age, sex, weight, height, address, etc.) that have been supplied by an investigator (see later). The database 422 also stores investigator details (such as name, address, etc.).

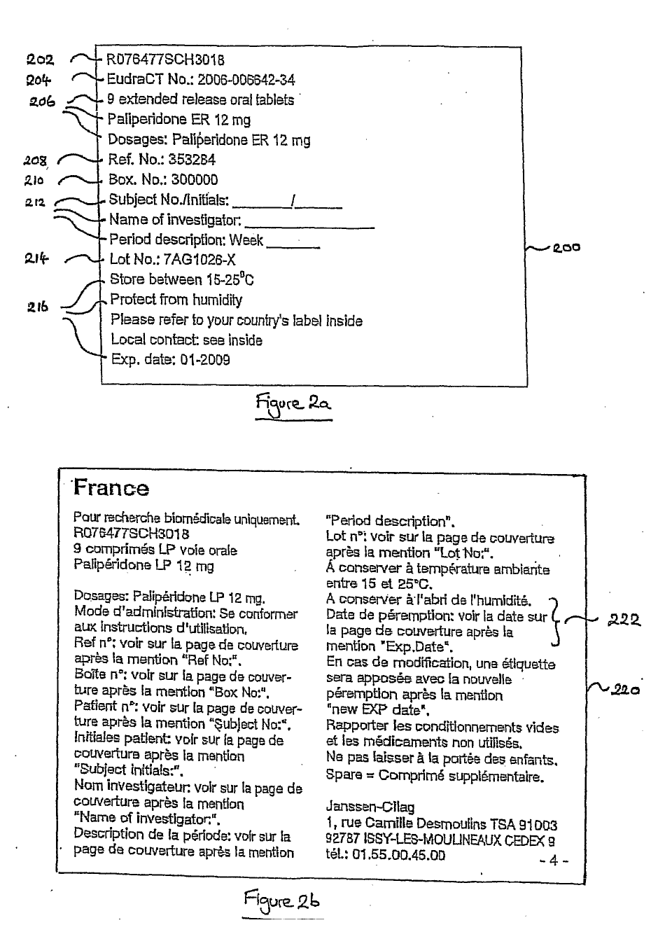

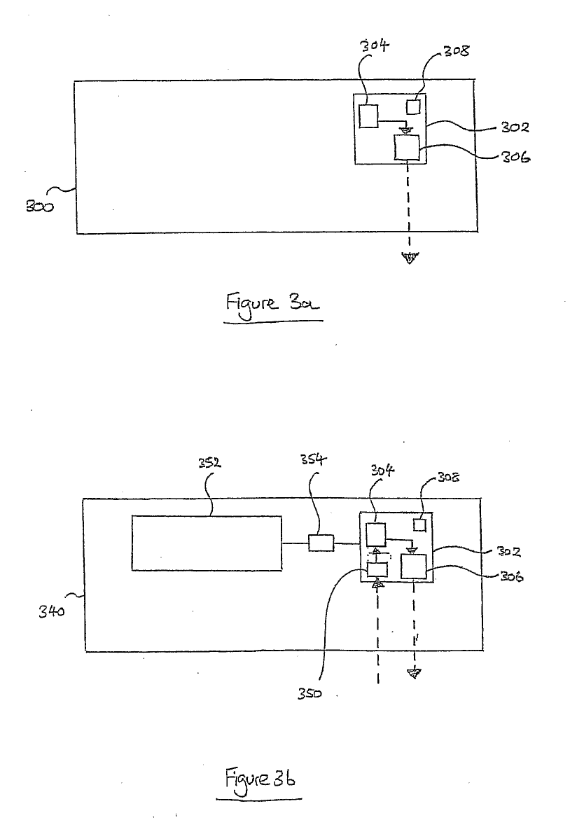

Additionally, the database 422 stores information concerning each package 300/340/380 that has been created for the clinical trial. The database 422 therefore stores a plurality of records, each record being associated with a corresponding package 300/340/380. The database 422 links the unique identifier of a package 300 to data related to (associated with) the corresponding package 300/340/380. In this way, the unique identifier may be used as a key within the database 422 to index (look-up) and retrieve (access) data relating to a corresponding package 300/340/380. This data may be, for example, any of the data that would have been used for the multi-lingual booklet (as shown in FIGS. 2a and 2b), such as expiry date. Additionally, information not provided with the multi-lingual booklet may also be stored in the database 422 in association with the unique identifier of the package 300/340/380, such as data regarding whether the drug provided with the package 300/340/380 is a placebo or an active compound and which investigator the package 300/340/380 has been distributed to.

The clinical trial system 420 is arranged to receive data from the investigator, via the investigator's computer 400. This information could be, for example: an identification of that particular investigator; details of a patient being admitted to the clinical trial; data identifying a package 300/340/380 to be given to or used by the patient; data identifying a package 300/340/380 that has been used by, and returned to, the investigator by a patient; or other data stored in the memory 304 of a package 300/340/380 and provided to the investigator's computer 400 via the transmitter 306 and the receiver 402.

The clinical trial system 420 is also arranged to provide data to the investigator (such as an identification of which package 300/340/380 should be provided to a particular patient).

The clinical trial system 420 may be run and organised by a single entity (company or organisation) at one location. Alternatively, various functionality of the clinical trial system 420 may be run and organised by different (separate) entities and/or at different (separate) locations. For example, (i) the management of the database 422 may be controlled by a data controller for the organisation conducting the clinical trial, adopting suitable security measures to protect patients' data and the trial results, whilst (ii) the interface between the investigator's computer 400 and the clinical trial system 420 may be managed by a different organisation providing a website interface for this, and other, clinical trials.

The database 422 may be organised as a single database or may be organised as multiple separate databases. When different entities and/or locations are used (as discussed above), the database 422 may be distributed across the different entities and/or locations.

The above-described system makes use of network-based communications (Internet, intranet, etc.) to communicate data between the investigator's computer 400 and the clinical trial system 420. Additionally, or alternatively, the clinical trial system 420 may use an interactive voice response unit. This may involve the use of speech-recognition to identify information spoken by the investigator over a telephone call made to the clinical trail system 420. Alternatively, the investigator can provide information (such as the unique identifier of a package 300/340/380 or patient details) to the clinical trial system 420 using the touch-pad (keys) of the telephone. The telephone buttons may also be used to navigate menus and/or options provided by the interactive voice response unit. Additionally, the clinical trial system 420 may then provide information back to the investigator as an audio communication over the telephone.

FIG. 5 is a flowchart schematically illustrating the operation of the system illustrated in FIG. 4a when a patient initially enrolls into a clinical trial.

At a step S500, the patient goes to the investigator to enroll in the clinical trial.

At a step S502, the patient provides his/her details to the investigator. These details may include age, sex (gender), address, height, weight, and known medical conditions, for example. The investigator, using the computer 400, then communicates these details to the clinical trial system 420, for example over the Internet. Additionally, the investigator identifies itself to the clinical trial system 420. To facilitate this, the clinical trial system 420 may host a website to provide the investigator with a user interface with which to enter, for example, the patient's details.

At a step S504, the clinical trial system 420 stores the patient's details in the database 422.

At a step S506, the clinical trial system 420 assigns a particular package 300/340/380 to the patient. As discussed above, the investigator will already have received a number of packages 300/340/380 that are to be provided to patients participating in the clinical trial. Knowing the identity of the investigator, the clinical trial system 420 assigns one of the packages 300/340/380 that the investigator possesses (and has not yet given to a patient) to the patient. The clinical trial system 420 may use none, some or all of the patient's details to determine which of the packages 300/340/380 to give to the patient, in a process known as randomisation. The package 300/340/380 provided to the patient may have a placebo or an active drug (compound or composition).

The clinical trial system 420 then informs the investigator which package 300/340/380 to give to the patient, so that, at a step S508, the investigator can find the appropriate package 300/340/380. To help the investigator find the correct package 300/340/380, the packages 300/340/380 may still be provided with the English-language label 200, from which the package 300/340/380 may be identified. (As discussed later, in some embodiments, data may be stored on a pharmaceutical supply package for presentation to a user, in which case the English language label provides a good backup in case of failure of the electronic device 302). Alternatively, the package 300/340/380 may simply have identification data (such as the box number 210 and/or the package order number 208) printed thereon to help the investigator identify the correct package 300/340/380. As a further alternative, the package 300/340/380 may have a barcode that the investigator can read (using a barcode reader), with the barcode being specific to the package 300/340/380.

Having retrieved a package 300/340/380 to give to the patient, at a step S510 the investigator uses the receiver 402 at the computer 400 to read the unique identifier stored in the memory 304 of the package 300/340/380. The investigator then sends the unique identifier to the clinical trial system 420.

The clinical trial system 420 then checks that the unique identifier received from the investigator corresponds to unique identifier of the package 300/340/380 that it intended the investigator to give to the patient. In this way, the clinical trial system 420 checks (or verifies) that that package 300/340/380 identified by the investigator is the package 300/340/380 that has been assigned to the patient. If the investigator has identified the correct package 300/340/380, then at a step S514 the clinical trial system 420 provides the investigator with an acknowledgement signal and updates the database 422 with details relating to the supply of the package 300/340/380 to the patient (such as associating the identity of the patient with the unique identifier of the package 300/340/380, storing the date of giving the patient the package 300/340/380, etc.). If the investigator has not identified the correct package 300/340/380, then at a step S516 the clinical trial system 420 provides the investigator with a no-acknowledgement signal.

At a step S518, the investigator determines whether an acknowledgement signal or a no-acknowledgement signal has been sent from the clinical trial system 420. If a no-acknowledgement signal has been sent to the investigator, then the computer 400 may provide a message, such as “Incorrect package—please locate correct package”, to the investigator. Processing returns to the step S508, at which the investigator tries to find the correct package 300/340/380.

However, if an acknowledgement signal has been sent to the investigator, then the computer 400 may provide a message, such as “Correct package—provide package to patient”, to the investigator. Then at a step S520, the investigator provides the patient with the package 300/340/380 so that, at a step S522, the patient can take the package 300/340/380 and use it in accordance with the clinical trial.

In this way, the unique identifier stored by the package 300/340/380 helps ensure that the investigator provides the correct package 300/340/380 to the correct patient. This helps eliminate human error at the investigator side, helps prevent potentially hazardous impacts on the patient's health (if the wrong (i.e. inappropriate) package 300/340/380 had been given to the patient) and helps ensure that the results of the clinical trial are accurate.

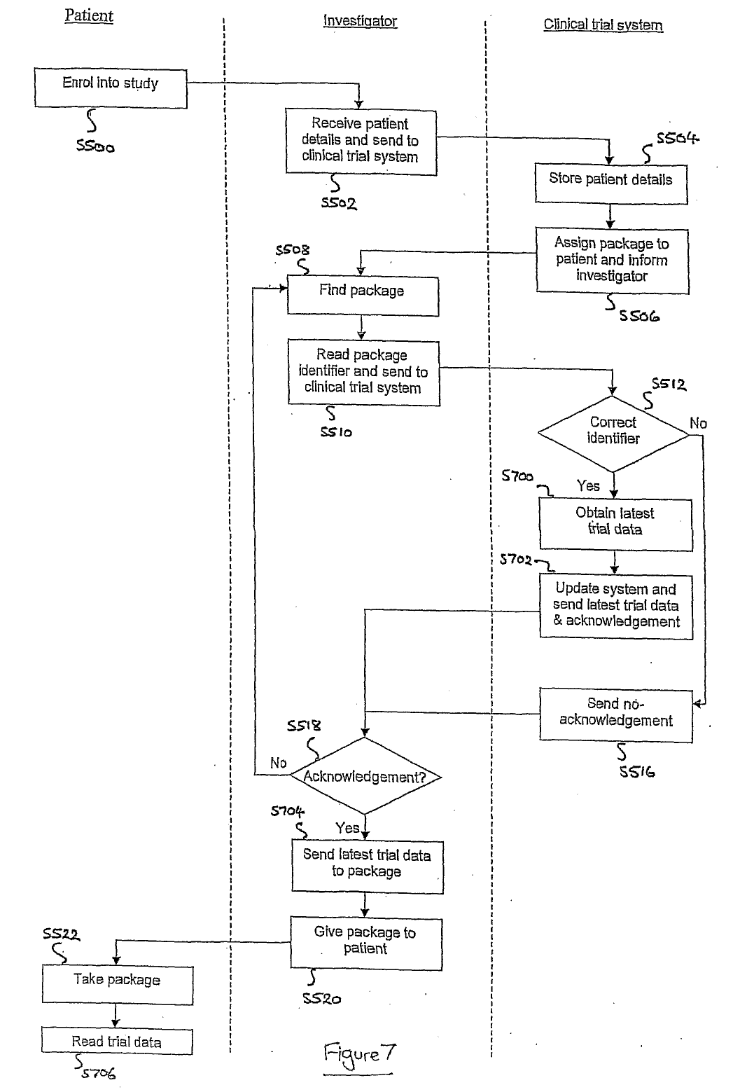

FIG. 6 is a flowchart schematically illustrating the operation of the system illustrated in FIG. 4a when a patient who has already enrolled into a clinical trial and has already been provided with a package 300/340/380 returns to the investigator. Some of the steps of FIG. 6 are the same as those of FIG. 5 and therefore have the same reference numeral. Such steps shall not be described again in detail.

At a step S600, the patient returns to the investigator and hands back the package 300/340/380 that the investigator initially gave them. The patient will, of course, have used some or all of the pharmaceutical product initially provided with the package 300/340/380.

At a step S602, the investigator uses the receiver 402 of the computer 400 to read the unique identifier from the patient's package 300/340/380. The computer 400 may also read other data that may be stored in the memory 304 of the package 300/340/380. For example, as discussed above, the package 300/340/380 may be arranged so that the electronic device 302 determines and records which of the blisters 106 have been opened by a patient and when they were opened. This information may also be read by the computer 400 from the package 300/340/380 via the transmitter 306 and receiver 402.

The investigator then sends the information that has been read from the package 300/340/380 to the clinical trial system 420. Additionally, the investigator may send further information, not read from the package 300/340/380, to the clinical trial system 420, such as data relating to the health of the patient (e.g. general health, side-effects of the pharmaceutical product being trialled, etc.)

At a step S604, the clinical trial system 420 stores the data that it has received from the investigator in the database 422.

At a step S606, the clinical trial system 420 assigns a new or next package 300/340/380 to the patient. This is similar to the step S506 of FIG. 5. However, as the patient has already been given a previous package 300/340/380, the clinical trial system 420 checks the database 422 to determine what kind of package 300/340/380 the patient was previously given so that an appropriate package 300/340/380 may be selected. For example, if the patient had been given a placebo, then the next package 300/340/380 should also contain a placebo; similarly, if the patient had been given an active drug, then the next package 300/340/380 should also contain an active drug. Hence, the clinical trial unit 420 identifies an appropriate package 300/340/380 (in accordance with the conduct of the clinical trial) that should be given to the patient by the investigator.

The clinical trial system 420 then informs the investigator which package 300 to give to the patient

After this, the process continues in accordance with the steps S508, S510, S512, S514 or S516, S518, S520 and S522, as discussed with reference to FIG. 5.

In this way, the unique identifier stored by the package 300/340/380 helps ensure that appropriate packages 300/340/380 are provided to the patient throughout the clinical trial (e.g. always providing a placebo or always providing an active drug with a specific dosage and usage regime). This helps eliminate human error at the investigator side, helps prevent potentially adverse impacts on the patient's health and helps ensure that the results of the clinical trial are accurate.

FIG. 4b schematically illustrates another system according to an embodiment of the invention. The system of FIG. 4b is similar to the system of FIG. 4a. However, in FIG. 4b, a receiver-transmitter 440 (input-output device) is used instead of the receiver 402 of FIG. 4a, and the pharmaceutical supply package that is used is a package 340 according to FIG. 3b.

The receiver-transmitter 440 is arranged to receive data transmitted from the package 340 (via the transmitter 306) and to transmit data to the package 340 (via the receiver 350). Data stored in the memory 304 of the package 340 may be read and communicated to the clinical trial system 420 in the same manner as described above with reference to FIG. 4a. Additionally, the investigator may use the computer 400 to load and store data into the memory 304 of the package 340, such as data received from the clinical trial system 420 or data generated at (or entered at) the computer 400.

The receiver-transmitter 440 may be comprise any receiver suitable for cooperating with the transmitter 306 of the package 340 and any transmitter suitable for cooperating with the receiver 350 of the package 340. The receiver-transmitter 440 may be integral to the computer 400 or may be a separate device coupled to the computer 400 (for example, via a USB connection).

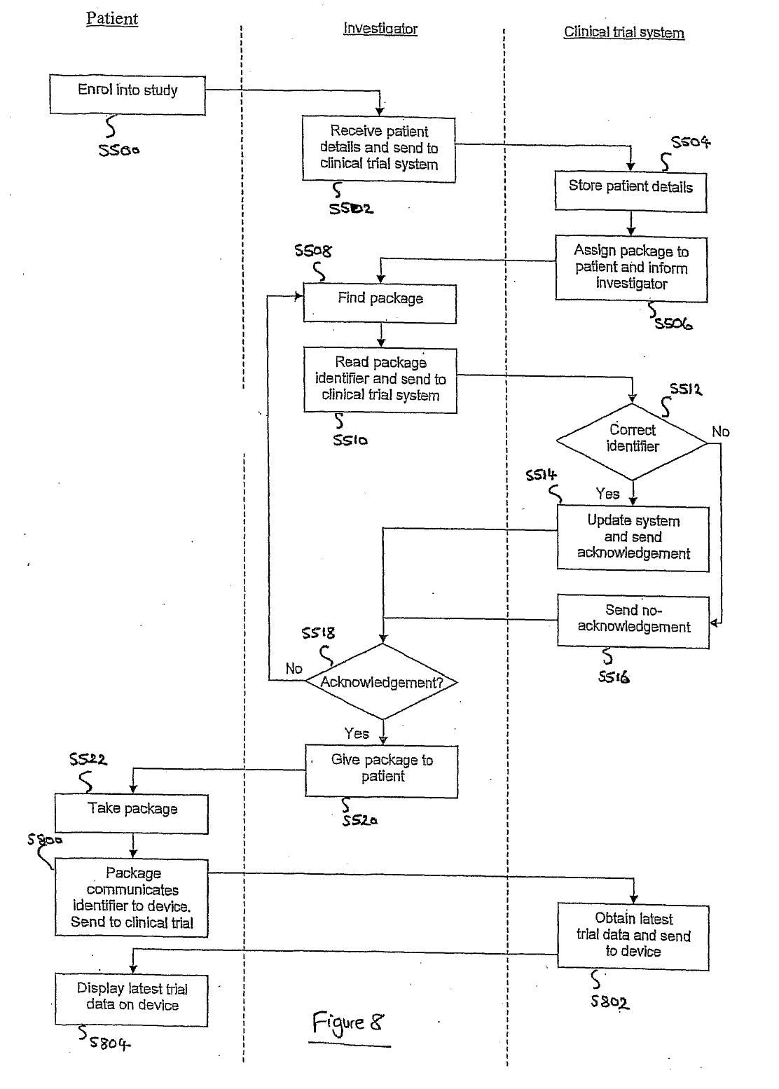

FIG. 7 is a flowchart schematically illustrating the operation of the system illustrated in FIG. 4b when a patient initially enrolls into a clinical trial.

FIG. 7 is very similar to FIG. 5, and the steps of FIG. 7 that are the same as those of FIG. 5 have the same reference numeral. Such steps shall not be described again in detail.

In FIG. 5, once the clinical trial system 420 had confirmed (at the step S512) that the investigator had selected the correct package 340 for the patient, processing continued at the step S514. However, in FIG. 7, the step S514 is replaced by steps S700 and S702.

At the step S700, the clinical trial system 420 identifies (obtains) some or all of the latest trial data relevant to (associated with) the package 340 that is to be given to the patient. This information is retrieved from the database 422, and the clinical trial system uses the unique identifier for the patient's package 340 to index (access) the data associated with that package 340 being stored in the database 422. This can be done by any known database access technique.

The data that the clinical trial system 420 retrieves from the database 422 is data that is to be displayed on the display 352 of the package 340. This data may include some, or all, of the information illustrated in FIG. 2a, i.e. the information that would otherwise have been displayed via the English-language label 200.

As mentioned above, the expiry date relevant to the package 340 may change during the course of the clinical trial, the recommended consumption regime for the drug being trialled may by adjusted during the course of the trial, etc. When these details are changed, the database 422 is updated so that it contains the most up-to-date information pertinent to the clinical trial and the packages 340 used in the clinical trial.

Then, at the step S702, the clinical trial system 420 sends (supplies) both the data retrieved at the step S700 and an acknowledgement signal to the investigator.

At the step S518, if the investigator receives an acknowledgement signal, then processing continues at a step S704 before continuing at the step S520.

At the step S704, the investigator transmits the data associated with the package 340 that it has received from the clinical trial system 420 to the package 340, using the receiver-transmitter 440 and the receiver 350 of the package 340.

In this way, the most up-to-date data associated with that package 340 can be loaded and stored in the memory 304 of the package 340. In addition, the investigator may provide information (e.g. name of a particular doctor, etc.) that can be transmitted to the package 340 for storage in the memory 304.

Once the patient has taken the package 340 away for use (at the step S522), the patient may access the data associated with the package 340 at a step S706 so that it is displayed on the display 352 of the package 340. For example, the patient may use the switch 354 to activate the display 352, so that some or all of the data stored in the memory 304 is displayed visually by the display 352.

The data may be formatted for display on the display 352 in various ways, as appropriate for the size and/or resolution of the display 352, etc. However, the language in which the data is displayed may be tailored according to the requirements of the patient. For example, the clinical trial system 420 may determine an appropriate language to use based on the address of the patient or the investigator. Alternatively, when the patient is enrolled into the clinical trial, one element of the patient data that is obtained by the investigator and communicated to the clinical trial system 420 may be an indicator of a preferred language. In these ways, the clinical trial system 420 may determine and associate an appropriate language with the package 340. When sending the data to the investigator, at the step S702, the clinical trial system 420 may format and/or translate the data according to the language to be used for the package 340. Hence, the patient's package 340 will receive data in a language suitable for the patient.

Alternatively, the clinical trial system 420 may simply send raw data (e.g. expiry date, humidity levels, etc.) to the investigator at the step S702, without explanatory text (e.g. “Expiry date:”, “Humidity level:”, etc.). The investigator's computer may then itself translate and/or process the raw data to generate data in a language suitable for the patient.

In this way, the package 340 does not require a multi-lingual booklet. The data stored in the memory 304 for display on the display 352 may be stored in a language suitable for the patient. This allows new languages to be easily incorporated into the clinical trial without having to manufacture, distribute and use replacement multi-lingual booklets.

Furthermore, the data that is stored in the memory 304 is the data that is most up-to-date at the time of dispensing the package 340 to the patient. Hence, any problems associated with multi-lingual booklets, labels etc. in connection with changing the data such expiry date, consumption regime, storage conditions, etc. are overcome.

A patient who has already enrolled into the clinical trial and has already been given, and used, a package 340, may return to the investigator to obtain a next (subsequent) package 340. In this case, the method illustrated in FIG. 6 applies equally to the system of FIG. 4b, except that: (i) the step S514 of FIG. 6 is replaced by the steps S700 and S702 of FIG. 7 (in a similar manner to the way the step S514 of FIG. 5 was replaced in FIG. 7 by the steps S700 and S702); (ii) the additional step S704 of FIG. 7 is used between the steps S518 and S520 of FIG. 6; and (iii) the patient may access the data associated with the replacement package 340 in the same manner as described with reference to the step S706.

FIG. 4c schematically illustrates another system according to an embodiment of the invention. The system of FIG. 4c is similar to the system of FIG. 4b, although in FIG. 4c, the pharmaceutical supply package used makes use of a receiver 350, so that the pharmaceutical supply package may be a package 340 of FIG. 3b or a package 380 of FIG. 3c.

In FIG. 4c, the patient (or, indeed, anybody else) uses a device (or terminal) 450 (such as a mobile telephone, personal digital assistant, computer, etc.). The device 450 has a display 452 suitable for displaying information (such as clinical trial information stored in the memory 304 of the package 340/380, e.g. the information found on the English-language label 200 of FIG. 2a).

The device 450 is capable of receiving data transmitted to it from the package 340/380. In this way, the device 450 may have a receiver similar to that used by the receiver-transmitter 440 of FIG. 4c. For example, the device 450 may be a Bluetooth-enabled device capable of communicating, via Bluetooth, with the package 340/380. Devices known as NFC devices (Near-Field-Communication devices) are therefore particularly suitable, as these devices can communicate with the package 340/380 when they are brought into close proximity with the package 340/380. However, devices that require a physical connection to receive and/or transmit data may also be used instead, and the skilled person will appreciate that any known communication technique for communicating data between the device 450 and the package 340/380 may be used.

The method of operating the system of FIG. 4c is the same as that shown in FIG. 7 for operating the system of FIG. 4b. However, the step S706 of FIG. 7 may be altered to allow for an alternative method for allowing the patient to read the data associated with the package 340/380 from the memory 304 of the package 340/380. The package 340/380 is arranged to transmit some or all of its data to the device 450, for example when the device 450 is brought close enough to the package 340/380 (or even into contact with the package 340/380) so that the package 340/380 and the device 450 can communicate with each other. The device 450 can then display the data that has been transmitted to it and that it has received on its display 452.

In this way, the pharmaceutical supply package need not be provided with its own display (e.g. the package 380 of FIG. 3c). Additionally, if the pharmaceutical supply package does have its own display 352 (e.g. the package 340 of FIG. 3b) but its own display 352 is broken, then the patient can still access the data in the memory 304 of the package 340 via the device 450. Additionally, the use of the device 350 means that the package 340/380 need not be provided with a multi-lingual booklet, thereby overcoming the above-mentioned problems associated with such booklets.

Of course, if a package 340 of FIG. 3b is being used, then the patient may still use the display 352 of the package 340 to display some or all of the data stored in the memory 304 of the package 340.

FIG. 4d schematically illustrates another system according to an embodiment of the invention. The system of FIG. 4d is similar to the system of FIG. 4c, although in FIG. 4d, the pharmaceutical supply package used does not necessarily require a receiver 350 for receiving data to store in its memory 304, so that the pharmaceutical supply package may be a package 300 of FIG. 3a, a package 340 of FIG. 3b or a package 380 of FIG. 3c.

In the system of FIG. 4d, the device 450 and the package 300/340/380 are arranged to communicate with each other so that the package 300/340/380 may transmit the unique identifier for that package 300/340/380, stored in the memory 304, to the device 450.

Additionally, the clinical trial system 420 is arranged so that it can communicate with the device 450. This may be achieved, for example, by the device 450 being capable of connecting to the network 430 (e.g. an Internet-enabled mobile telephone) or may be achieved by the device 450 and the clinical trial system 420 being capable of receiving, processing, generating and sending telephonic communications (such as text messages by SMS or MMS). Such techniques for communicating data between the device 450 and the clinical trial system 420 are well known and shall not be described in more detail herein.

FIG. 8 is a flowchart schematically illustrating the operation of the system illustrated in FIG. 4d when a patient initially enrolls into a clinical trial. FIG. 8 is the same as FIG. 5, except that it has steps that follow the final step, S522, of FIG. 5. The steps of FIG. 8 that are the same as those of FIG. 5 have the same reference numeral. Such steps shall not be described again in detail.

After the patient has taken the package 300/340/380 at the step S522, the patient, at a step S800, arranges for the package 300/340/380 to communicate the identifier stored in the memory 304 to the device 450. For example, for near-field-communication devices, this involves bringing the device 450 and the package 300/340/380 sufficiently close to each other such that they can communicate with each other, the package 300/340/380 on detection of the device 450 in its proximity then automatically transmitting its unique identifier. The device 450 then communicates the unique identifier to the clinical trial system 420. This may be done automatically by the device 450, or the patient may compose a suitable message (e.g. SMS text message or email) to send to the clinical trial system 420.

Upon receipt of the unique identifier, the clinical trial system 420, at the step S802, identifies (obtains) some or all of the latest trial data relevant to the package 300/340/380 that has been given to the patient. This is similar to the processing performed at the step S700 of FIG. 7. The clinical trial system 420 then communicates this data back to the device 450.

Then, at a step S804, the device 450, having received the data from the clinical trial system 420, displays the data on the display 452 of the device 450. If the pharmaceutical supply package being used also has a receiver 350, then the device 450 may transmit the data that it has received to the package 340/380 so that the data may then be stored in the memory 304.

In this way, the patient may obtain the most up-to-date information relating to their pharmaceutical supply package without having to visit the investigator. Thus, any updates to the clinical trial data provided to the patient that have been implemented after the patient last visited the investigator will be available to the patient.

A patient who has already enrolled into the clinical trial and has already been given, and used, a package 300/340/380, may return to the investigator to obtain a next (subsequent) package 300/340/380. In this case, the method illustrated in FIG. 6 applies equally to the system of FIG. 4d, except that the patient may access the data associated with the package 300/340/380 by using the steps S800, S802 and S804 of FIG. 8.

It will be appreciated that various modifications may be made to the above example systems and method of operation. For example, a patient need not physically visit the investigator, but may instead enroll online via the Internet, with the investigator then arranging for the appropriate package 300/340/380 to be delivered to the patient by post or mail. The patient can then return used packages 300/340/380 to the investigator by post or mail.

Additionally, a package 340 of FIG. 3b could be used in the system of FIG. 4d, with the electronic device 302 being adapted to communicate directly with the clinical trial system 420. In this way, the patient does not need to use another device 450—instead, the package 340 can send its own identifier directly to the clinical trial system 420, requesting the latest data related to that package 340, with then clinical trial system 420 then returning that data directly to the package 340 for display on the display 352 and/or storage in the memory 304.

Additionally, at the step S704 of FIG. 7 at which the package 340/380 had the latest clinical trial data loaded into its memory 304, the investigator's computer 400 may be arranged to print a separate label, displaying this clinical trial data. The investigator can then attach this label to the package 340/380 as an additional or alternative means for the patient to view the relevant data.

Furthermore, in the methods illustrated in FIGS. 7 and 8, the verification (validation) performed by steps S510, S512, S514, S516 and S518 need not be carried out. For example, these steps could be omitted from FIG. 8 and, in FIG. 7, the steps S700 and S702 could be combined with the step S506 so that, when assigning the pharmaceutical supply package to the patient at the step S506, the clinical trial system 420 also communicates the latest trial data relevant to the package to the investigator.

It will be appreciated that, insofar as embodiments of the invention are implemented by a computer program, then a storage medium and a transmission medium carrying the computer program form aspects of the invention.

1-25. (canceled)

26. A pharmaceutical supply package comprising:
a memory storing an identifier specific to the pharmaceutical supply package;
a transmitter operable to transmit the identifier for reception by a reception device external to the pharmaceutical supply package; and
a receiver operable to receive data and to store the received data in the memory.

27. A pharmaceutical supply package according to claim 26, comprising a display for providing a visual display of at least some of the data stored in the memory.

28. A pharmaceutical supply package according to claim 27, in which the display requires electrical power to provide the visual display of the at least some of the data stored in the memory.

29. A pharmaceutical supply package according to claim 28, comprising a switch for causing the display to provide or to stop providing the visual display.

30. A pharmaceutical supply package according to claim 27, in which the display comprises:
a heat-sensitive component, wherein the visual appearance of the heat-sensitive component changes in response to application of heat to the heat-sensitive component; and
a heat-applicator arranged to apply heat to the heat-sensitive component to change the visual appearance of the heat-sensitive component to display the at least some of the data stored in the memory.

31. A pharmaceutical supply package according to claim 26, in which the transmitter is operable to transmit at least some data received by the receiver and stored in the memory for reception by, and display at, a device external to the pharmaceutical supply package.

32. A system comprising:
a pharmaceutical supply package, the pharmaceutical supply package comprising: a memory storing an identifier specific to the pharmaceutical supply package; and a transmitter operable to transmit the identifier for reception by a reception device external to the pharmaceutical supply package;
a reception device operable to receive, from the pharmaceutical supply package, the identifier specific to the pharmaceutical supply package; and
a control system operable to communicate with the reception device and comprising a database storing data associated with a plurality of pharmaceutical supply packages, wherein the control system can retrieve the data associated with a pharmaceutical supply package using the identifier specific to that pharmaceutical supply package;
wherein the control system is arranged to assign a pharmaceutical supply package to a user; and
wherein the control system, on receipt from the reception device of an identifier received by the reception device from a particular pharmaceutical supply package, is arranged to check that the particular pharmaceutical supply is the pharmaceutical supply package assigned to the user.

33. The system according to claim 32, in which the pharmaceutical supply package comprises a receiver operable to receive data and to store the received data in the memory.

34. A system for conducting a clinical trial, the system comprising a system according to claim 32.

35. A system comprising:
a pharmaceutical supply package, the pharmaceutical supply package comprising: a memory storing an identifier specific to the pharmaceutical supply package; a transmitter operable to transmit the identifier for reception by a reception device external to the pharmaceutical supply package; and a receiver operable to receive data and to store the received data in the memory;
a reception device operable to receive, from the pharmaceutical supply package, the identifier specific to the pharmaceutical supply package; and
a control system operable to communicate with the reception device and comprising a database storing data associated with a plurality of pharmaceutical supply packages, wherein the control system can retrieve the data associated with a pharmaceutical supply package using the identifier specific to that pharmaceutical supply package;
wherein the reception device is operable, upon receipt of the identifier specific to the pharmaceutical supply package, to communicate the identifier to the control system to obtain, from the database, some or all of the data associated with the pharmaceutical supply package, the control system being operable to communicate the some or all of the data associated with the pharmaceutical supply package to the reception device; and
wherein the reception device is operable to supply the obtained data to the pharmaceutical supply package via the receiver of the pharmaceutical supply package.

36. A system according to claim 35,
wherein the pharmaceutical supply package comprises a display for providing a visual display of at least some of the data stored in the memory, wherein the display comprises: a heat-sensitive component, wherein the visual appearance of the heat-sensitive component changes in response to application of heat to the heat-sensitive component; and a heat-applicator arranged to apply heat to the heat-sensitive component to change the visual appearance of the heat-sensitive component to display the at least some of the data stored in the memory,
wherein the system comprises a terminal operable to receive, from the pharmaceutical supply package, data stored in the memory of the pharmaceutical supply package and transmitted by the pharmaceutical supply package; wherein the terminal comprises a display for providing a visual display of at least some of the data received by the terminal from the pharmaceutical supply package.

37. A system according to claim 36, in which the terminal is a personal mobile device.

38. A system for conducting a clinical trial, the system comprising a system according to claim 35.

39. A system comprising:
a pharmaceutical supply package, the pharmaceutical supply package comprising: a memory storing an identifier specific to the pharmaceutical supply package; a transmitter operable to transmit the identifier for reception by a reception device external to the pharmaceutical supply package; and a receiver operable to receive data and to store the received data in the memory;
a device operable to receive, from the pharmaceutical supply package, the identifier specific to the pharmaceutical supply package; and
a control system operable to communicate with the device and comprising a database storing data associated with a plurality of pharmaceutical supply packages, wherein the control system can retrieve the data associated with a pharmaceutical supply package using the identifier specific to that pharmaceutical supply package;
wherein the device is operable, upon receipt of the identifier specific to the pharmaceutical supply package, to communicate the identifier to the control system to obtain, from the database, some or all of the data associated with the pharmaceutical supply package, the control system being operable to communicate the some or all of the data associated with the pharmaceutical supply package to the device; and
wherein the device comprises a display for providing a visual display of at least some of the received data to a user of the device.

40. A system according to claim 39, in which the device is a personal mobile device.

41. A system for conducting a clinical trial, the system comprising a system according to claim 39.

42. A method of using a pharmaceutical supply package, the pharmaceutical supply package comprising: a memory storing an identifier specific to the pharmaceutical supply package; and a transmitter operable to transmit the identifier for reception by a reception device external to the pharmaceutical supply package; wherein the method comprises:
assigning, to a user, a particular pharmaceutical supply package intended for use by the user;
identifying a pharmaceutical supply package;
determining whether the identifier specific to the identified pharmaceutical supply package corresponds to the identifier specific to the pharmaceutical supply package assigned to the user; and
if the identifier specific to the identified pharmaceutical supply package corresponds to the identifier specific to the pharmaceutical supply package assigned to the user, providing the identified pharmaceutical supply package to the user.

43. A method according to claim 42, in which the pharmaceutical supply package comprises a receiver operable to receive data and to store the received data in the memory.

44. A method of conducting a clinical trial, the method comprising carrying out a method according to claim 42.

45. A method of using a pharmaceutical supply package, the pharmaceutical supply package comprising: a memory storing an identifier specific to the pharmaceutical supply package; a transmitter operable to transmit the identifier for reception by a reception device external to the pharmaceutical supply package; and a receiver operable to receive data and to store the received data in the memory; wherein the method comprises:
receiving the identifier specific to the pharmaceutical supply package;
accessing a database that stores data associated with a plurality of pharmaceutical supply packages, by using the received identifier to retrieve some or all of the data associated with the pharmaceutical supply package; and
storing the retrieved data in the memory of the pharmaceutical supply package.

46. A method according to claim 45, wherein the pharmaceutical supply package comprises a display for providing a visual display of at least some of the data stored in the memory, the method comprising:
displaying, on the display of the pharmaceutical supply package, at least some of the data stored in the memory of the pharmaceutical supply package.

47. A method according to claim 45, comprising:
transmitting at least some of the data stored in the memory of the pharmaceutical supply package to a device, the device having a display; and
displaying, on the display of the device, at least some of the data transmitted to the device by the pharmaceutical supply package.

48. A method according to claim 45, comprising formatting the data retrieved from the database into a predetermined language.

49. A method of conducting a clinical trial, the method comprising carrying out a method according to claim 45.

50. A method of using a pharmaceutical supply package, the pharmaceutical supply package comprising: a memory storing an identifier specific to the pharmaceutical supply package; a transmitter operable to transmit the identifier for reception by a reception device external to the pharmaceutical supply package; and a receiver operable to receive data and to store the received data in the memory; wherein the method comprises:
transmitting the identifier specific to the pharmaceutical supply package from the pharmaceutical supply package to a device, the device having a display;
using the received identifier to access a database that stores data associated with a plurality of pharmaceutical supply packages and retrieve some or all of the data associated with the pharmaceutical supply package; and
displaying, on the display of the device, at least some of the data retrieved from the database.

51. A method according to claim 50, comprising formatting the data retrieved from the database into a predetermined language.

52. A method of conducting a clinical trial, the method comprising carrying out a method according to claim 50.

53. A computer readable medium carrying a computer program for carrying out a method of using a pharmaceutical supply package, the pharmaceutical supply package comprising: a memory storing an identifier specific to the pharmaceutical supply package; and a transmitter operable to transmit the identifier for reception by a reception device external to the pharmaceutical supply package; wherein execution of the computer program by a processor causes the processor to carry out the steps of:
assigning, to a user, a particular pharmaceutical supply package intended for use by the user;
identifying a pharmaceutical supply package;
determining whether the identifier specific to the identified pharmaceutical supply package corresponds to the identifier specific to the pharmaceutical supply package assigned to the user; and
if the identifier specific to the identified pharmaceutical supply package corresponds to the identifier specific to the pharmaceutical supply package assigned to the user, providing the identified pharmaceutical supply package to the user.

54. A computer readable medium carrying a computer program for carrying out a method of using a pharmaceutical supply package, the pharmaceutical supply package comprising: a memory storing an identifier specific to the pharmaceutical supply package; and a transmitter operable to transmit the identifier for reception by a reception device external to the pharmaceutical supply package; wherein execution of the computer program by a processor causes the processor to carry out the steps of:
receiving the identifier specific to the pharmaceutical supply package;
accessing a database that stores data associated with a plurality of pharmaceutical supply packages, by using the received identifier to retrieve some or all of the data associated with the pharmaceutical supply package; and
storing the retrieved data in the memory of the pharmaceutical supply package.

55. A computer readable medium carrying a computer program for carrying out a method of using a pharmaceutical supply package, the pharmaceutical supply package comprising: a memory storing an identifier specific to the pharmaceutical supply package; and a transmitter operable to transmit the identifier for reception by a reception device external to the pharmaceutical supply package; wherein execution of the computer program by a processor causes the processor to carry out the steps of:
transmitting the identifier specific to the pharmaceutical supply package from the pharmaceutical supply package to a device, the device having a display;
using the received identifier to access a database that stores data associated with a plurality of pharmaceutical supply packages and retrieve some or all of the data associated with the pharmaceutical supply package; and
displaying, on the display of the device, at least some of the data retrieved from the database.
